(19) United States
(12) Patent Application Publication
(10) Pub. No.: US 2005/0262478 A1
(43) Pub. Date: Nov. 24, 2005

(54) Logging last resource

(75) Inventors: Thomas E. Barnes, Whitehouse Station, NJ (US); Adam Messinger, San Francisco, CA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/130,558

(22) Filed: May 17, 2005

Related U.S. Application Data
(60) Provisional application No. 60/573,263, filed on May 21, 2004.

(51) Int. Cl. G06F 9/44

(52) U.S. Cl. 717/118

(57) ABSTRACT

A logging last resource (LLR) system can provide a transaction log and transaction data to a LLR resource after a number of two-phase-commit resources have been prepared. The LLR resource manager can operate on the transaction log and transaction data in an atomic fashion so that the one-phase or local commit can be done. The one-phase or local commit can be done by the LLR manager in an atomic manner.

### CLAIM OF PRIORITY

This application claims priority to U.S. Provisional Application No. 60/573,263 entitled “Logging Las Resource” filed May 21, 2004, by Thomas E. Barnes et al. [Attorney Docket No. BEAS-01 587US0]

### FIELD OF INVENTION

The present invention relates to transactions using multiple resources.

### BACKGROUND OF INVENTION

In many cases, transaction processing requires the use of multiple resources. Typically, each of the resources can maintain Atomic, Consistent, Isolated, and Durable (ACID) properties. A transaction manager is often used to maintain the ACID properties over multiple resources. For example, consider a single transaction involving the changing of an account balance in a database and sending of a wire transfer. It is crucial that both portions of the transaction either both occur or both do not occur. Otherwise, either the bank balance is debited without a wire transfer or the funds are transferred without debiting the bank account. Such a failure of the transaction is called a heuristic failure. If neither portions of the transaction occur, the transaction can rolled back and tried again.

### BRIEF DESCRIPTION OF THE DRAWINGS

FIG. 1A illustrates a system in which each of the resource managers for a transaction are two-phase-commit resource managers.

FIG. 1B illustrates a transaction system using a last resource optimization.

FIG. 2 illustrates a transaction system using a logging last resource.

FIG. 3 illustrates an embodiment using a connection pool for the logging last resource.

### DETAILED DESCRIPTION

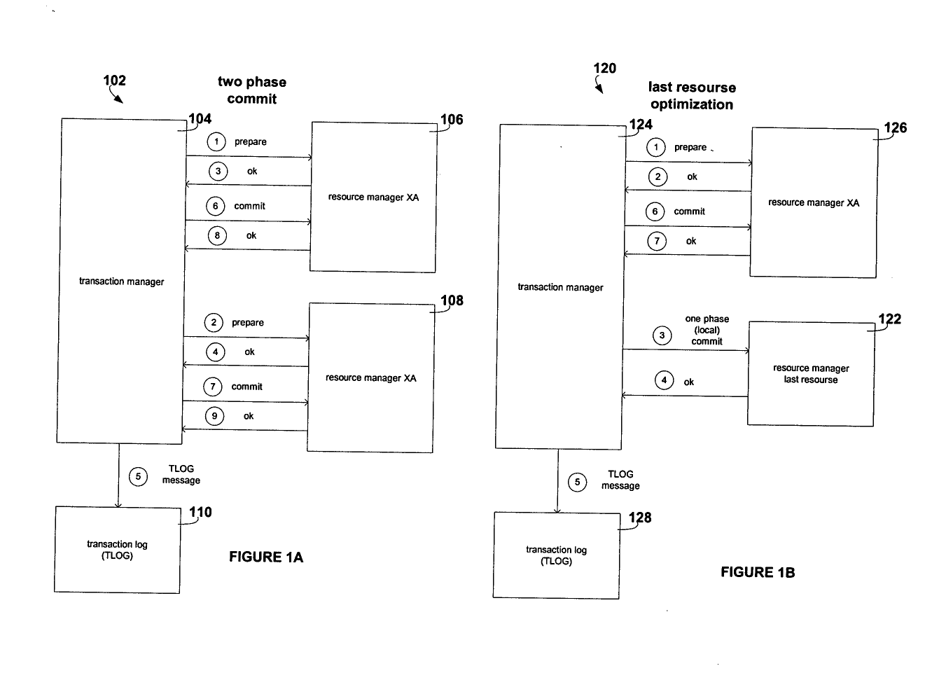

FIG. 1A illustrates a two-phase-commit system 102. In this embodiment, the transaction manager 104 can send prepare instructions to the two-phase-commit resource managers 106 and 108. After both the two-phase-commit resource managers send their OK in steps 3 and 4, a transaction log 110 is stored by the transaction manager 104, in step 5. After the transaction log is stored, the transaction manager 104 instructs the resource managers 106 and 108 to commit, in steps 6 and 7. The resource managers send back their OK after the commit, in steps 8 and 9.

The two-phase-commit transaction system 102 is fully ACID. If the system crashes before the transaction log is stored, the transaction manager 104 rolls back the transaction. If the system crashes after the transaction log is written, the transaction manager 104 can then cause the resource managers 106 and 108 to commit.

It is sometime difficult to have an optimized or efficient resource manager for some resources. For example, databases often have inefficient resource managers. One attempt to avoid this problem is shown in the system of FIG. 1B. In the last resource optimization (LRO) system 120, one of the resource managers 122 does a single phase or local commit. In this example, the transaction manager 124 sends prepare signal instructions to each of the two-phase-commit resource managers, including the two-phase-commit resource manager 126. Once an OK is received from each of the two-phase-commit resource managers the transaction log 128 can be stored and a one-phase or local commit sent to the resource manager 122. Once the OK is received from the last resource 122 in a one-phase or local commit, the transaction manager 124 can cause each two-phase commit resource managers to do their commit. If the last resource manager 122 fails in the one-phase or local commit, there can be a heuristic failure that the transaction manager 124 does not know to fix.

The transaction manager 124 can wait until the OK is received from the resource manager of the last resource 122 before storing a transaction log. Even in this case, if both the resource manager 122 and transaction manager 124 go down after the resource manager 122 is able to commit, but before the transaction log 128 is able to be stored, then the transaction will be committed for the resource associated with the resource manager 122, but not for the resources associated with the two-phase-commit resource managers.

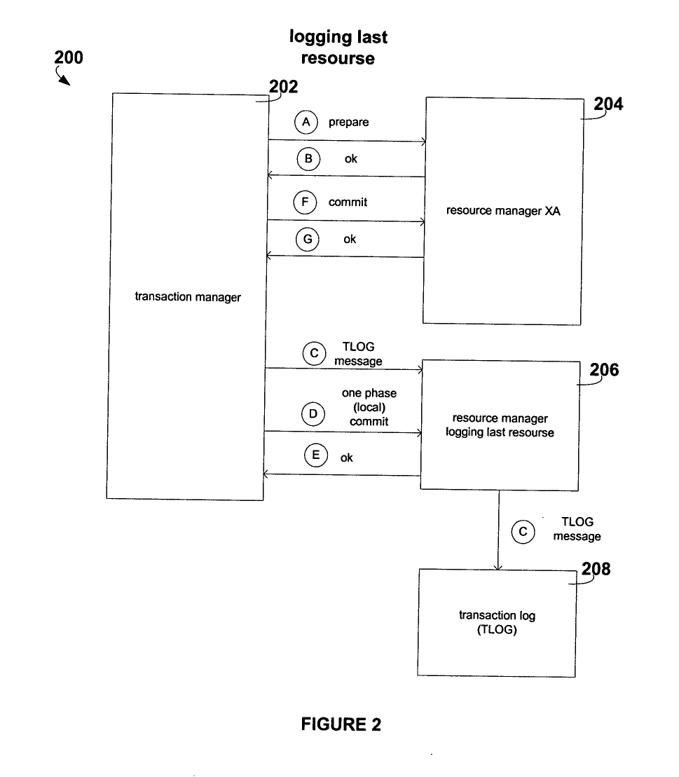

FIG. 2 shows a logging last resource (LLR) system 200 for transactions. LLR system 200 includes a transaction manager 202. The transaction manager 202 can interact with a two-phase-commit resource manager 204 and a Logging Last Resource (LLR) resource manager 206.

The LLR resource manager 206 can use a single-phase or local commit and can store a transaction log 208 for the transaction manager 202. There can be multiple two-phase-commit resource managers used in a transaction, but, in one embodiment, only a single LLR resource manager is used.

In one embodiment, the LLR system 200 is fully ACID. The LLR resource manager 206 can store the transaction log (TLOG) 208 and do a one-phase or local commit in a single atomic operation. Either the transaction log 208 is stored and the resource manager 206 commits or the transaction log 208 is not stored and the LLR resource manager 206 does not commit. If the transaction log 208 is stored, that means that the transaction manager 202 can assume that the resource manager 206 has committed and can instruct the two-phase-commit resource managers, including the resource manager 204 to commit. If the transaction log 208 is not stored, this means that the resource manager 206 has not committed and the transaction managers knows that no resources have committed. The transaction manager 202 can then rollback the transaction and the transaction can be reattempted.

The LLR system 200 of one embodiment has the advantage that the LLR resource manager 206 can operate with a one-phase or local commit which can significantly improve the speed of the entire transaction. This increased speed does not result in additional heuristic failure risk because the LLR system 200 can be fully ACID.

In one embodiment, the LLR system 200 uses a significant fewer number of memory stores than the system shown in FIG. 1A. The transaction log and transaction data can be stored in a single write. The LLR resource manager 206 also does not use prepare writes. In one example, if the system of FIG. 1A requires five writes, the system of FIG. 2 only requires only three writes.

The resource of the LLR resource manager 206 can be a database, a messaging service, such as the Java Messaging Service, or any other type of resource. The LLR resource manager 206 can be part of or associated with the resource.

The LLR resource manager 206 can deal with the transaction log and transaction data in an atomic manner. For example, a database can store the transaction log and transaction data atomically, and a messaging service can store the transaction log and message transaction data atomically. The resource of the LLR resource manager 206 can operate in an atomic manner.

The LLR resource manager 206 can include a connection pool used to connect to the database. The connection pool can be on the same server as transaction manager. Having the connection pool on the same server as transaction manager helps maintain the atomicity of connection pools operation on the transaction log and the transaction data.

The connection pool can be a Java Database Connectivity (JDBC) connection pool for connecting to a database. A single connection of the connection pool can be used to store the transaction log and transaction data into the database. In one embodiment, the transaction manager can recover from crashes during the transaction.

One LLR implementation can work without a modification of the database or its client connection. The database resource manager code can be implemented in a “LLR connection pool” and wraps a standard JDBC connection. This LLR implementation supports ACID participation of databases even if the database doesn't implement the standard XA protocol since a “non-XA” JDBC connection can be used Furthermore, in this implementation, application programs commonly require no modification to switch from XA standard JDBC connections to LLR capable JDBC connections. Such a switch can be accomplished via a simple administrative change. Finally, in this implementation, applications can obtain LLR capable connections from one or more servers during a single transaction, and the implementation can transparently ensure that operations on these multiple connections all route to a single LLR capable connection reserved specifically for the transaction.

One method of the present invention includes instructing a two-phase-commit resource manager 204 to do a prepare phase of a transaction (step A of FIG. 1); receiving an OK from the two-phase commit resource manager 204 (step B); thereafter, instructing a logging last resource (LLR) resource manager 206 to do a local or one phase commit and store a transaction log (steps C and D); receiving an OK from the LLR resource manager (step E); and instructing the two-phase commit resource manager 204 to commit (step F).

The method can be done by transaction manager 202. The transaction log 208 can indicate that each of the two-phase commit resource managers has finished its prepare phase.

Another embodiment of the present invention is a method. At a logging last resource (LLR) resource manager 206, a transaction log for a multiple resource transaction and a single-commit instruction is received. The transaction log is stored and the transaction committed in a local or single-phase commit

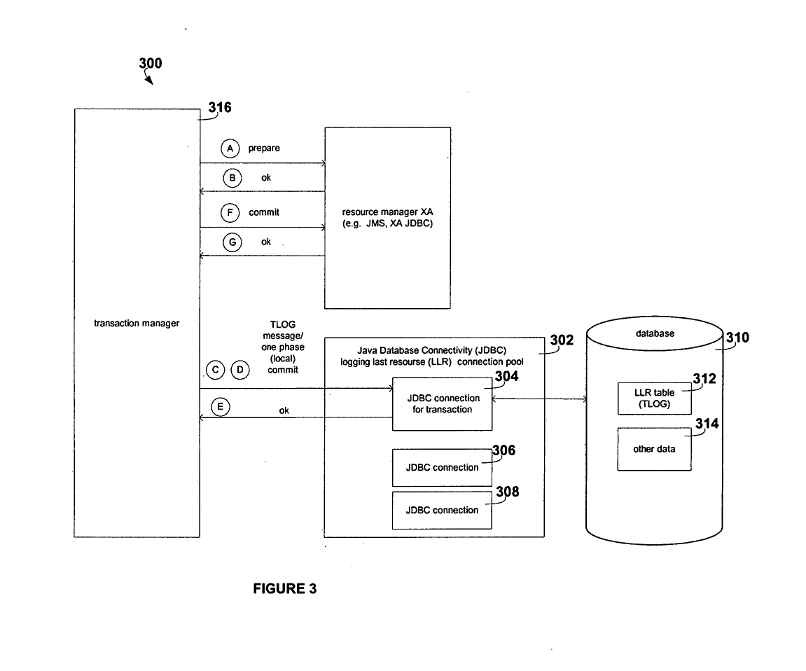

FIG. 3 shows an embodiment of a system 300 of the present invention. A connection pool 302 can comprise a number of connections 304, 306, and 308. One of connections 304 is used to operate on a transaction log for a multiple resource transaction and on transaction data for the transaction. Transaction data can be saved in a local or single phase commit.

The connection pool 302 can connect to a database 310. The database 310 can store the transaction log and transaction data. In one embodiment, the transaction log can be stored in LLR table 312 and the transaction data can be stored in region 314. The database 310 can store the transaction log and transaction data in an atomic manner. The connection pool 302 can be on the same server as the transaction manager 316. The connection pool can be a Java Database Connectivity (JDBC) connection pool. The transaction manager 316 can use the stored transaction log to recover from a crash.

Appendix I describes a non-limiting example of a LLR transaction system. Appendix II describes a non-limiting example of a Java Database Connectivity (JDBC) logging last resource (LLR) connection pool. The discussion of the implementation of the LLR resource manager, connection pools and other elements described in the Appendixes are understood to concern one embodiment and are not meant or believed to have the effect of limiting the meaning of these terms and concepts. The Appendixes are provided to illustrate how these concepts can be implemented in one exemplary embodiment. Language such as “should”, “must”, and “will” in the Appendixes pertain to the exemplary embodiment and are not meant to limit the claimed concepts.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, micro drive, and magneto-optical disks, ROMs, Rams, EPROM's, EPROM's, Drams, Rams, flash memory devices, magnetic or optical cards, Nan systems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps performed in the embodiments of the invention disclosed can be performed in alternate orders, certain steps can be omitted, and additional steps can be added. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

[image]

[image]

[image]

[image]

[image]

[image]

[image]

[image]

[image]

[image]

[image]

[image]

[image]

[image]

[image]

[image]

[image]

1. A method comprising:
at a logging last resource (LLR) resource manager, receiving a transaction log for a multiple resource transaction and a single-commit instruction;
storing the transaction log; and
committing to the transaction in a single phase commit.

2. The method of claim 1, wherein the resource of the LLR resource manager is a database.

3. The method of claim 2, wherein the database stores the transaction log and transaction data.

4. The method of claim 3, wherein the database stores the transaction log and transaction data in an atomic manner.

5. The method of claim 2, wherein the LLR resource manager includes a connection pool to connect to the database.

6. The method of claim 5, wherein the connection pool is on the same server as a transaction manager.

7. The method of claim 5, wherein the connection pool is a Java Database Connectivity (JDBC) connection pool.

8. The method of claim 5, wherein one connection of the connection pool is used to store the transaction log and transaction data into the database.

9. The method of claim 1, wherein a transaction manager can use the stored transaction log to recover from a crash.

10. The method of claim 1, wherein LLR resource manager is part of the resource.

11. The method of claim 1, wherein the resource of the LLR resource manager operates in an atomic manner.

12. A machine readable medium having instructions stored thereon that when executed by a processor cause a system to:
at a logging last resource (LLR) resource manager, receive a transaction log for a multiple resource transaction and a single-commit instruction;
store the transaction log; and
commit to the transaction in a single phase commit.

13. A connection pool comprising a number of connections, one of connections being used to operate on a transaction log for a multiple resource transaction and transaction data for the transaction, the transaction data being saved in a single phase commit.

14. The connection pool of claim of claim 13, wherein the connection pool connects to a database.

15. The connection pool of claim 14, wherein the database stores the transaction log and transaction data.

16. The connection pool of claim 14, wherein the database stores the transaction log and transaction data in an atomic manner.

17. The connection pool of claim 13, wherein the connection pool is on the same server as a transaction manager.

18. The connection pool of claim 13, wherein the connection pool is a Java Database Connectivity (JDBC) connection pool.

19. The connection pool of claim 13, wherein the one connection of the connection pool is to store the transaction log and transaction data into a database.

20. The connection pool of claim 13, wherein a transaction manager can use a stored transaction log to recover from a crash.
